(19) United States
(12) Patent Application Publication
(10) Pub. No.: US 2009/0256917 A1
(43) Pub. Date: Oct. 15, 2009

(54) POWER CONTROL METHOD FOR USE WITH EMBEDDED WEB CAMERA OF NOTEBOOK COMPUTER

(75) Inventors: WEI-PO LIN, Taipei (TW); HUNG-YI LIN, Taipei (TW)

Correspondence Address: WPAT, PC, 7225 BEVERLY ST., ANNANDALE, VA, 22003, US

(73) Assignee: ASUSTek COMPUTER INC., Taipei (TW)

(21) Appl. No.: 12/422,057

(22) Filed: Apr. 10, 2009

(30) Foreign Application Priority Data
Apr. 14, 2008 (TW) 097113476

(51) Int. Cl. H04N 5/225

(52) U.S. Cl. 348/207.11; 348/372; 348/E05.024

(57) ABSTRACT

A power control method is used with a video camera of a computer system. The power control method includes steps of executing a virtual web camera software to load a virtual web camera, executing a video application program such that the virtual web camera software generates a power-on message, and providing electric energy to the video camera in response to the power-on message.

### FIELD OF THE INVENTION

The present invention relates to a power control method for use with a web camera, and more particularly to a power control method for use with an embedded web camera of a notebook computer.

### BACKGROUND OF THE INVENTION

With increasing development of computer systems and networks, communication technologies have experienced great growth. For example, video signal can be transmitted through internet connection. FIG. 1 is a schematic perspective view illustrating a computer host connected with a web camera according to the prior art. As shown in FIG. 1, the web camera (or WebCAM) 20 has a USB interface. The computer host 10 is for example a notebook computer or a desktop computer. The computer host 10 has a USB port connected to a control chip (not shown), which is disposed within the computer host 10. The control chip has a power supply terminal (Vcc), a ground terminal (Gnd) and differential data terminals (D+, D−).

Generally, once the web camera 20 is inserted into the USB port of the computer host 10, the power supply terminal (Vcc) immediately provides power required for operation of the web camera 20. At the same time, the operating system (e.g. the Windows operating system) of the computer host 10 can acquire the product ID of the web camera 20 from the differential data terminals. According to the product ID, a suitable driver is searched and executed so as to load the web camera 20.

Generally, after the web camera 20 has been successfully loaded, an icon indicative of the web camera 20 is shown on the status bar of the operating system. By viewing this icon, the user can realize that the web camera 20 has been successfully loaded and the normal operation of the web camera 20 is rendered.

After the web camera 20 is inserted into the USB port of the computer host 10, the power supply terminal (Vcc) immediately provides power required for operation of the web camera 20 and thus the computer host 10 will continuously provide electric power to the web camera 20. In other words, the computer host 10 continuously consumes power unless the web camera 20 is pulled out from the USB port of the computer host 10.

FIG. 2 is a schematic perspective view illustrating a computer host having an embedded web camera according to the prior art. As shown in FIG. 2, the notebook computer 30 has an embedded web camera 40 and thus the user needs not purchase an additional web camera. If the embedded web camera 40 has a USB interface, the embedded web camera 40 is directly connected to the USB control chip (not shown) of the notebook computer 30 without the need of inserting into the USB port. Under this circumstance, the embedded web camera 40 is sure to be loaded once the notebook computer 30 is turned on. Moreover, since the embedded web camera 40 fails to be detached from the notebook computer 30, the embedded web camera 40 begins consuming power once the notebook computer 30 is turned on. Since the built-in battery of the notebook computer 30 continuously provides power required for operation of the embedded web camera 40, the use time of the built-in battery is reduced.

### SUMMARY OF THE INVENTION

The present invention relates to a power control method for use with an embedded web camera of a notebook computer so as to minimize power consumption.

In accordance with an aspect of the present invention, there is provided a computer system. The computer system includes a video camera, a control chip, a switch, a virtual web camera software and an ACPI driver. The control chip is connected to the video camera. The switch has two ends respectively connected to the control chip and the video camera. The switch is selectively controlled to turn on or turn off to transmit or stop transmitting electric energy from the control chip to the video camera. The control circuit can execute a video application program. The virtual web camera software generates a power-on message when the video application program is executed by the control circuit. The ACPI driver generates a driving signal in receipt of the power-on message, so that the switch is controlled to transmit the electric energy to the video camera in response to the driving signal.

In accordance with another aspect of the present invention, there is provided a power control method for use with a video camera of a computer system. The power control method includes steps of executing a virtual web camera software to load a virtual web camera, executing a video application program such that the virtual web camera software generates a power-on message, and providing electric energy to the video camera in response to the power-on message.

In accordance with a further aspect of the present invention, there is provided a power control method for use with an embedded video camera of a notebook computer. The power control method includes steps of executing a web camera software under an operating system, executing a video application program and issuing an enabling command, intercepting the enabling command and controlling an ACPI driver to close a switch of a motherboard of the notebook computer by the web camera software such that electric energy is transmitted to the embedded video camera, and transferring the enabling command to the embedded video camera through the web camera software, thereby enabling the embedded video camera.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic perspective view illustrating a computer host connected with a web camera according to the prior art;

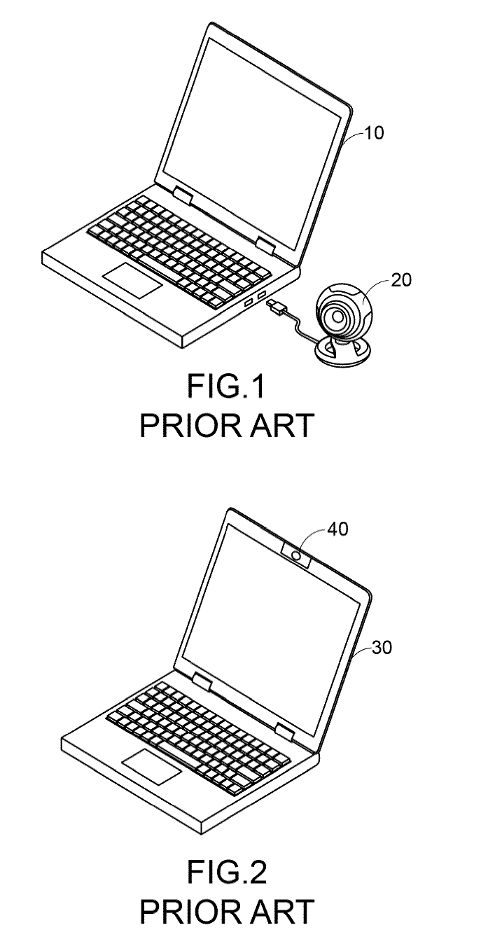

FIG. 2 is a schematic perspective view illustrating a computer host having an embedded web camera according to the prior art;

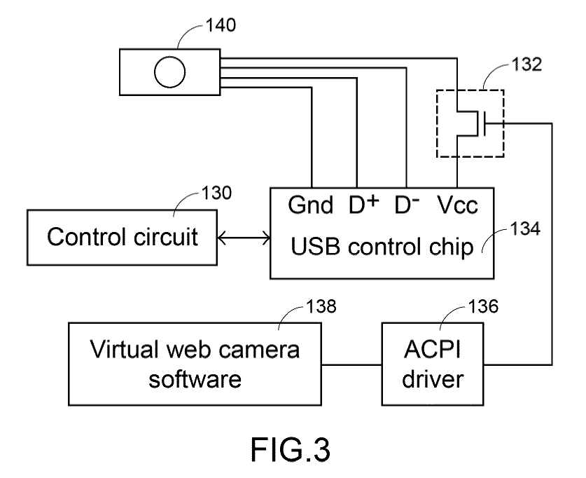

FIG. 3 is a schematic perspective view illustrating a power control system for use with an embedded web camera of a notebook computer according to a preferred embodiment of the present invention;

FIGS. 4A and 4B schematically illustrate a flowchart of a power control method for use with an embedded web camera of a notebook computer under the Windows operating system; and

FIG. 5 is a flowchart illustrating a power control method for use with an embedded web camera of a notebook computer under the Linux operating system.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

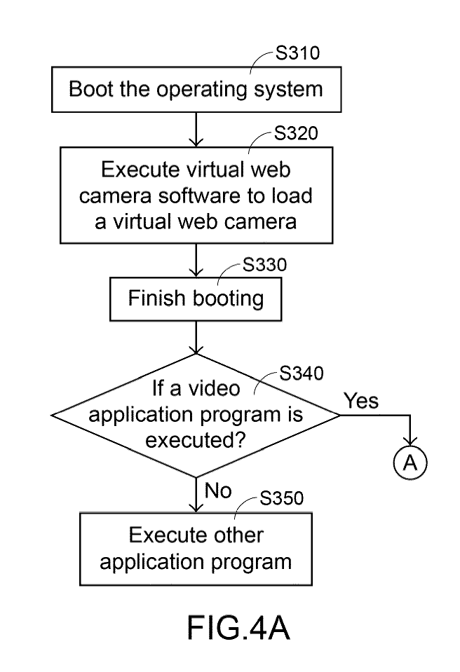

FIG. 3 is a schematic perspective view illustrating a power control system for use with an embedded web camera of a notebook computer according to a preferred embodiment of the present invention. The power control system is employed to reduce power consumption during operations of the embedded web camera 140 of the notebook computer. As shown in FIG. 3, the power control system comprises a control circuit 130, a power switch 132, a USB control chip 134, an ACPI (Advanced Configuration & Power Interface) driver 136 and a virtual web camera software 138. The power switch 132 is for example a power field-effect transistor (Power FET). The USB control chip 134 has a power supply terminal (Vcc), a ground terminal (Gnd) and differential data terminals (D+, D−). The power switch 132 is interconnected between the power supply terminal (Vcc) of the USB control chip 134 and the power input terminal of the embedded web camera 140. The power switch 132 is controlled by the ACPI driver 136. After the power supply terminal (Vcc) of the USB control chip 134 is electrically connected to the embedded web camera 140, the control circuit 130 detects the product ID of the embedded web camera 140 and the embedded web camera 140 is activated. The control circuit 130 comprises a central processing unit, a north bridge chip and a south bridge chip.

In a case that the video application program is executed under the Windows operating system rather than the control circuit, the power switch 132 is in an open state. In the open state, the connection between two ends of the power switch 132 is interrupted; for example, the connection between the source electrode and the drain electrode of a power FET is interrupted. Under this circumstance, the embedded web camera 140 is not electrically connected to the power supply terminal (Vcc) of the USB control chip 134 and thus no electric energy is consumed. On the other hand, if the video application program is executed by the control circuit, the power switch 132 is in a close state (turn off). In the close state, the connection between two ends of the power switch 132 is conducted; for example, the connection between the source electrode and the drain electrode of a power FET is conducted. Under this circumstance, the embedded web camera 140 is electrically connected to the power supply terminal (Vcc) of the USB control chip 134 such that the electric energy is provided from the USB control chip 134 to the embedded web camera 140.

Moreover, if the video application program is disabled, the power switch 132 is changed to the open status again under control of the ACPI driver 136. Meanwhile, since the embedded web camera 140 is not electrically connected to the power supply terminal (Vcc) of the USB control chip 134, no electric energy is consumed.

Moreover, the virtual web camera software 138 is executed when the computer system is booted under the Windows operating system, thereby providing a virtual web camera. After the virtual web camera has been successfully loaded, an icon indicative of the virtual web camera is shown on the status bar of the operating system. By viewing this icon, the user may deem that a physical web camera has been successfully loaded and the normal operation of the physical web camera is rendered. In reality, however, the embedded web camera 140 has not been electrically connected to the power supply terminal (Vcc) of the USB control chip 134.

In an embodiment, the virtual web camera is provided by the virtual web camera software 138 through a KSProxy interface of the Windows operating system. In other words, since the virtual web camera software is designed on the basis of the KSProxy interface, the virtual web camera has the control interface conforming to the specifications of the Windows operating system. As a consequence, when the computer system is booted under the Windows operating system, the virtual web camera is detected. Under this circumstance, the virtual web camera is deemed as a physical web camera by the user and the video application program.

Moreover, when the video application program is executed by the control circuit 130, the virtual web camera is enabled and thus the virtual web camera software 138 generates a power-on message to the ACPI driver 136. In receipt of the power-on message, the ACPI driver 136 issues a driving signal to the power switch 132. In response to the driving signal, the power switch 132 is in the close state such that the power input terminal of the embedded web camera 140 is electrically connected to the power supply terminal (Vcc) of the USB control chip 134. Meanwhile, the embedded web camera 140 is actually loaded under the Windows operating system. As a result, the embedded web camera 40 and the video application program can be employed to transmit video data.

On the other hand, after the video data transmission has finished and the video application program is disabled, the virtual web camera software 138 generates a power-off message to the ACPI driver 136. In response to the power-off message, the power switch 132 is changed to the open state (turn on) such that the power input terminal of the embedded web camera 140 is no longer electrically connected to the power supply terminal (Vcc) of the USB control chip 134. Under this circumstance, no electric energy is consumed.

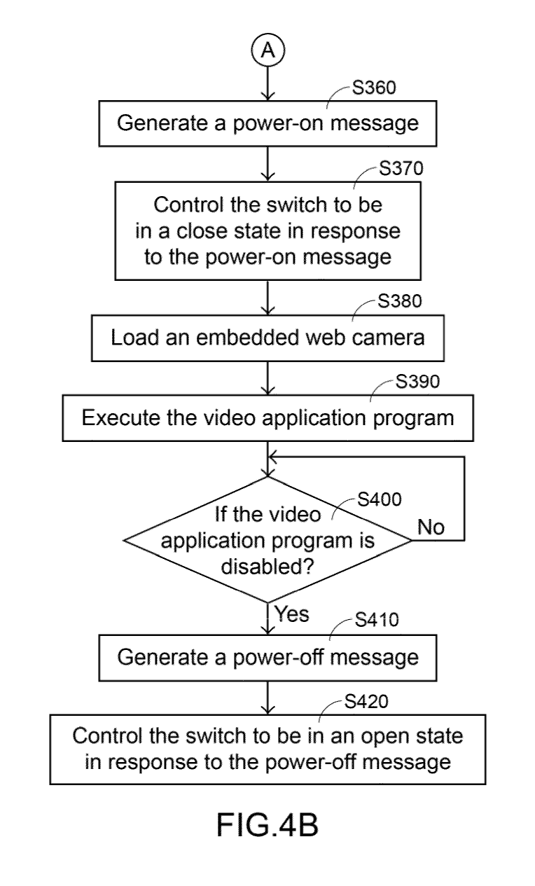

FIGS. 4A and 4B schematically illustrate a flowchart illustrating a power control method for use with an embedded web camera of a notebook computer under the Windows operating system.

After the computer system is powered on and booted under the Windows operating system (Step S310), the virtual web camera software is executed such that a virtual web camera is loaded by the Windows operating system (Step S320). Meanwhile, the booting procedure is finished (Step S330).

If a video application program is executed (Step S340), the virtual web camera software generates a power-on message to the ACPI driver (Step S360); otherwise, other application program is executed (Step S350). After the power-on message is received by the ACPI driver, the power switch is controlled to be in the close state (Step S370). Meanwhile, the embedded web camera is actually loaded under the operating system (Step 380).

Next, the video application program is executed such that the embedded web camera can transmit video data (Step S390). In a case that the video application program is disabled (Step S400), the virtual web camera software generates a power-off message to the ACPI driver (Step S410). After the power-off message is received by the ACPI driver, the power switch is controlled to be in the open state (Step S420). Meanwhile, the embedded web camera 140 is not electrically connected to the power supply terminal (Vcc) of the USB control chip 134, and thus no electric energy is consumed.

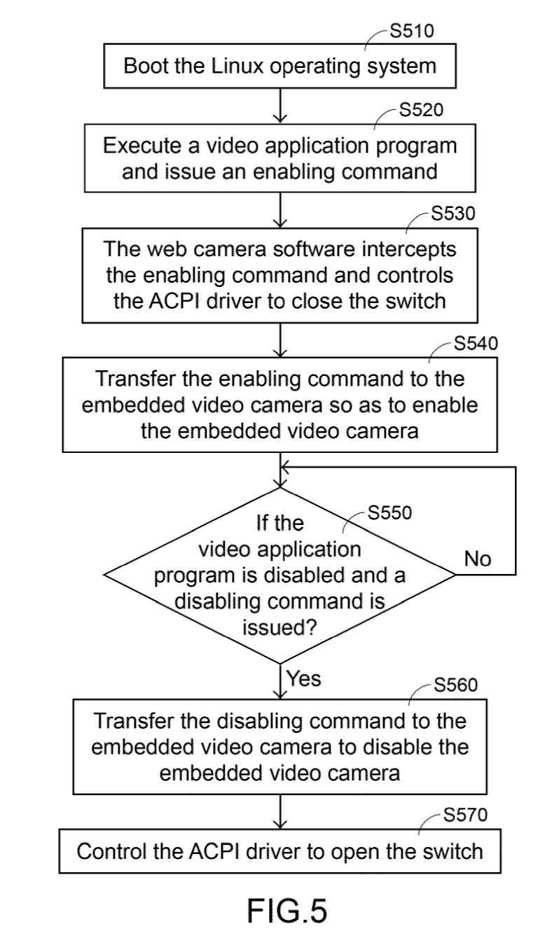

The power control method can also be used under the Linux operating system. FIG. 5 is a flowchart illustrating a power control method for use with an embedded web camera of a notebook computer under the Linux operating system.

After the computer system is powered on and booted under the Linux operating system (Step S510), a web camera software is executed. Next, a video application program is executed and an enabling command is issued through the web camera software (Step S520). The web camera software intercepts the enabling command and controls the ACPI driver to close the power switch, so that the embedded web camera is electrically connected to the power supply terminal (Vcc) of the USB control chip (Step S530). Next, the enabling command is transferred to the embedded video camera, thereby enabling the embedded video camera (Step S540).

In a case that the video application program is disabled and a disabling command is issued by the video application program (Step S550), the disabling command is transferred to the embedded video camera through the web camera software, thereby disabling the embedded video camera (Step S560). Next, the web camera software controls the ACPI driver to open the power switch, thereby stopping transmitting the electric energy to the embedded video camera (Step S570).

From the above embodiment, if the embedded video camera of the notebook computer is not used, the power switch is controlled to be in an open status such that the embedded web camera is not electrically connected to the power supply terminal. Whereas, if the embedded video camera is used, the power switch is controlled to be in a close status such that the embedded web camera is electrically connected to the power supply terminal. Accordingly, the power control method of the present invention is capable of reducing power consumption and thus extending the use life of the built-in battery of the notebook computer.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A computer system comprising:
a video camera;
a control chip connected to the video camera;
a switch having two ends respectively connected to the control chip and the video camera, wherein the switch is selectively controlled to turn on or turn off to transmit or stop transmitting electric energy from the control chip to the video camera;
a control circuit for executing a video application program;
a virtual web camera software generating a power-on message when the video application program is executed by the control circuit; and
an ACPI driver generating a driving signal in receipt of the power-on message, so that the switch is controlled to transmit the electric energy to the video camera in response to the driving signal.

2. The computer system according to claim 1 wherein the control chip is a USB control chip.

3. The computer system according to claim 2 wherein the USB control chip further comprises a ground terminal and differential data terminals, which are connected to the video camera.

4. The computer system according to claim 1 wherein the switch is a power field-effect transistor.

5. The computer system according to claim 1 wherein when the video application program is disabled by the control circuit, the virtual web camera software generates a power-off message and the switch is controlled to stop transmitting the electric energy to the video camera in response to the power-off message.

6. The computer system according to claim 1 wherein the video camera is an embedded web camera.

7. A power control method for use with a video camera of a computer system, the power control method comprising steps of:
executing a virtual web camera software to load a virtual web camera;
executing a video application program such that the virtual web camera software generates a power-on message; and
providing electric energy to the video camera in response to the power-on message.

8. The power control method according to claim 7 wherein the power system further comprises an ACPI driver and a switch, and the switch is controlled to transmit the electric energy to the video camera when the power-on message is received by an ACPI driver.

9. The power control method according to claim 8 further comprising steps of:
disabling the video application program such that the virtual web camera software generates a power-off message; and
stopping transmitting the electric energy to the video camera in response to the power-off message.

10. The power control method according to claim 9 wherein the switch is controlled to stop transmitting the electric energy to the video camera in response to the power-off message.

11. A power control method for use with an embedded video camera of a notebook computer, the power control method comprising steps of:
executing a web camera software under an operating system;
executing a video application program and issuing an enabling command;
intercepting the enabling command and controlling an ACPI driver to close a switch of a motherboard of the notebook computer by the web camera software, so that electric energy is transmitted to the embedded video camera; and
transferring the enabling command to the embedded video camera through the web camera software, thereby enabling the embedded video camera.

12. The power control method according to claim 11 further comprising steps of:
disabling the video application program and issuing a disabling command;
transferring the disabling command to the embedded video camera through the web camera software, thereby disabling the embedded video camera; and
controlling the ACPI driver to open the switch by the web camera software, thereby stopping transmitting the electric energy to the embedded video camera.
